(19) United States
(12) Patent Application Publication
(10) Pub. No.: US 2009/0046688 A1
(43) Pub. Date: Feb. 19, 2009

(54) Method and System for Providing Broadband Multimedia Services

(76) Inventors: John P. Volpi, Garland, TX (US); Matthew N. Bowers, Dallas, TX (US); John A. Moore, Austin, TX (US); Sanjay Kulkarni, Plano, TX (US)

Correspondence Address: SLATER & MATSIL, L.L.P., 17950 PRESTON RD, SUITE 1000, DALLAS, TX, 75252-5793, US

(21) Appl. No.: 12/258,278

(22) Filed: Oct. 24, 2008

Related U.S. Application Data
(63) Continuation of application No. 10/794,507, filed on Mar. 5, 2004.
(60) Provisional application No. 60/452,371, filed on Mar. 6, 2003.

(51) Int. Cl. H04W 4/00

(52) U.S. Cl. 370/338

(57) ABSTRACT

A wireless router access point for use with a mesh network employing a mesh protocol and a point-to-multipoint network employing a point-to-multipoint protocol, and a multimedia system employing the same. In one embodiment, the wireless router access point includes a mesh access point subsystem configured to translate between a point-to-multipoint protocol and a mesh protocol to communicate with the mesh network. The wireless router access point also includes a point-to-multipoint access point subsystem configured to translate between a mesh protocol and a point-to-multipoint protocol to communicate with a user of the point-to-multipoint network.

### CROSS REFERENCE TO RELATED APPLICATIONS

This application is a continuation of U.S. patent application Ser. No. 10/794,507, filed on Mar. 5, 2004, entitled “Method and System for Providing Broadband Multimedia Services,” which claims the benefit of U.S. Provisional Application No. 60/452,371, filed on Mar. 6, 2003, entitled “A Method and System for Providing Broadband Multimedia Services,” both of which applications are hereby incorporated herein by reference.

### TECHNICAL FIELD

The present invention is directed, in general, to communication systems and, more specifically, to a multimedia system employable with a tiered wireless network architecture.

### BACKGROUND

Recent improvements in wireless technologies have promoted the rapid adoption of cellular phones worldwide. A similar adoption of portable computing devices capable of multimedia services is currently under way. Practical and cost effective wireless networks to provide voice capacity have evolved over the recent decades. The wireless networks are designed to utilize scarce spectrum resources to provide service across the broadest possible geographic areas for the greatest number of users. The multimedia services employ substantially more bandwidth to deliver a product that is acceptable to the users, which is further complicated by a need to achieve reasonable network performance. At the same time, delivering a system that is economically feasible demands significantly more spectrum than is now feasible.

In parallel to the aforementioned trends, a standardization of protocols on a worldwide basis to support broadband services utilizing unlicensed spectrum is evolving. While this promotes a creation of portable network extensions within a home or office environment, it does not provide a platform for efficient or effective wide area public networks. While there are no prohibitions in the United States against the use of unlicensed spectrum portable network extensions in the public networks, there are severe limitations on the acceptable emissions which significantly reduces the coverage therefrom.

The use of point-to-multipoint radios may provide a solution to a back haul problem (i.e., the effective allocation of network resources to transmit wireless information such as voice or data communications from a user employing the laptop computer or the like over, for instance, the Internet), but it provides little improvement in network performance or manageability. Also, the manageability and reliability of the public networks is impaired if single points of failure are widely dispersed. Even if it were practical to have a large number of low cost radios blanketing a neighborhood or other localized area, from a practical standpoint, establishing a high quality service that penetrates the walls of buildings and still provides adequate throughput is very difficult at these lower emission levels.

Accordingly, what is needed in the art is a multimedia system capable of providing broadband multimedia services to users employing, preferably, wireless devices such as cellular phones, portable computing devices, or the like employable with a tiered wireless network architecture that addresses concerns such as back haul problems and limitations of available spectrum and overcomes the deficiencies in the prior art.

### SUMMARY OF THE INVENTION

These and other problems are generally solved or circumvented, and technical advantages are generally achieved, by advantageous embodiments of the present invention which includes a wireless router access point for use with a mesh network employing a mesh protocol and a point-to-multipoint network employing a point-to-multipoint protocol, and a method of operating the same. In one embodiment, the wireless router access point includes a mesh access point subsystem configured to translate between a point-to-multipoint protocol and a mesh protocol to communicate with the mesh network. The wireless router access point also includes a point-to-multipoint access point subsystem configured to translate between a mesh protocol and a point-to-multipoint protocol to communicate with a user of the point-to-multipoint network.

In another aspect, the present invention provides a multimedia system for use with a mesh network employing a mesh protocol and a point-to-multipoint network employing a point-to-multipoint protocol. The multimedia system includes a plurality of wireless router access points and a concentrator wireless router access point. In one embodiment, the wireless router access points includes a mesh access point subsystem configured to translate between a point-to-multipoint protocol and a mesh protocol to communicate with the mesh network. The wireless router access points also include a point-to-multipoint access point subsystem configured to translate between a mesh protocol and a point-to-multipoint protocol to communicate with a user of the point-to-multipoint network. The concentrator wireless router access point includes a wireless router access point subsystem configured to provide a wireless interface and functionality to communicate with one of the plurality of wireless router access points. The concentrator wireless router access point also includes a control/interface subsystem configured to provide control functions to manage the plurality of wireless router access points. The multimedia system may also include a cluster feeder configured to provide a bridging function between the user and ones of the plurality of wireless router access points or the concentrator wireless router access point.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, reference is now made to the following descriptions taken in conjunction with the accompanying drawings, in which:

FIG. 1 illustrates a block diagram of an embodiment of a tiered wireless network architecture in accordance with the principles of the present invention;

FIG. 2 illustrates a block diagram of an embodiment of a partner/customer network constructed according to the principles of the present invention;

FIG. 3 illustrates a block diagram of an embodiment of a regional/national data center constructed according to the principles of the present invention;

FIG. 4 illustrates a block diagram of an embodiment of a back haul/aggregation network constructed according to the principles of the present invention;

FIG. 5 illustrates a block diagram of an embodiment of a cluster constructed according to the principles of the present invention;

FIG. 6 illustrates a block diagram of an embodiment of portions of a cluster constructed according to the principles of the present invention;

FIGS. 7A and 7B illustrate block diagrams of alternative embodiments of a wireless router access point constructed according to the principles of the present invention;

FIGS. 8A and 8B illustrate block diagrams of alternative embodiments of a concentrator wireless router access point constructed according to the principles of the present invention;

FIGS. 9A and 9B illustrate diagrams of alternative configurations for cluster feeders constructed according to the principles of the present invention;

FIGS. 10A, 10B and 10C illustrate block diagrams of alternative embodiments of a cluster feeder constructed according to the principles of the present invention; and

FIGS. 11 to 13 illustrate block diagrams of alternative embodiments of wireless networks, or portions thereof, that provide an environment for an application of a multimedia system constructed according to the principles of the present invention.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The present invention will be described with respect to preferred embodiments in a specific context, namely, a wireless router access point in the environment of a multimedia system and related methods of delivering broadband multimedia services. The principles of the present invention, however, may also be applied to other types of access points and controllers employable with tiered wireless network architectures. The advantages associated with the wireless router access point and multimedia system further exploit the benefits associated with wireless communications and can further exploit the advantages of growing the availability of the broadband multimedia services in a viral manner nationally or internationally. For purposes of clarity, devices capable of communicating wirelessly with a wireless network may be referred to as wireless devices.

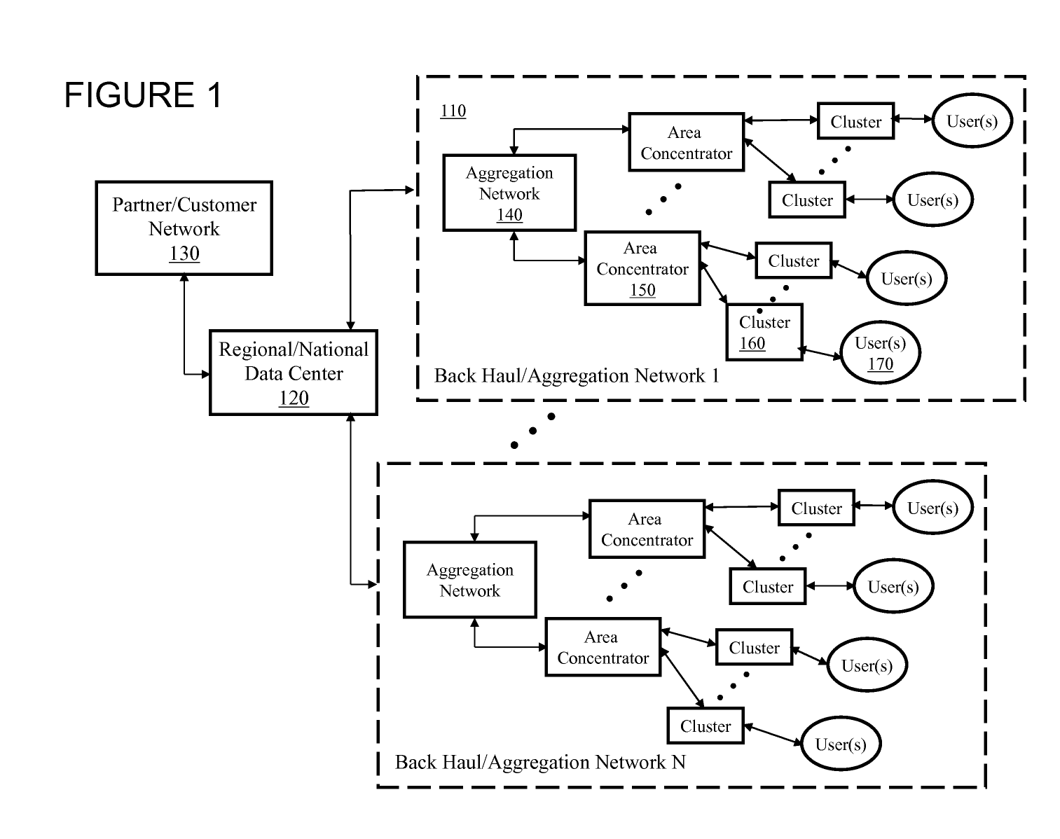

Referring initially to FIG. 1, illustrated is a block diagram of an embodiment of a tiered wireless network architecture (also referred to as a “wireless network”) in accordance with the principles of the present invention. The wireless network is configured to provide ubiquitous, wireless connectivity at designated locations and seamlessly extend that connectivity to other networks as well as the Internet. Within the wireless network are back haul/aggregation networks (one of which is designated 110). The number of back haul/aggregation networks 110 depends on the specific areas to be served by a multimedia system and can vary from a single network to a multitude of networks and still be within the broad scope of the present invention.

The back haul/aggregation networks 110 are connected to a regional/national data center 120 which aggregates the entire network and provides primary connectivity to a partner/customer network 130. The back haul/aggregation networks 110 include an aggregation network 140 and at least one area concentrator (one of which is designated 150). The number of area concentrators 150 depends on the areas served by the aggregation network 140 and can vary from a single unit to a multitude of units.

A plurality of clusters (one of which is designated 160) are connected to the area concentrator 150 and each cluster 160 forms a wireless local area network. The number of clusters 160 supported by each area concentrator 150 depends on a size and area distribution thereof. The clusters 160 serve users (one of which is designated 170) within a proximity of the cluster 160. As illustrated, the multimedia system is employable within an environment of a tiered wireless network architecture.

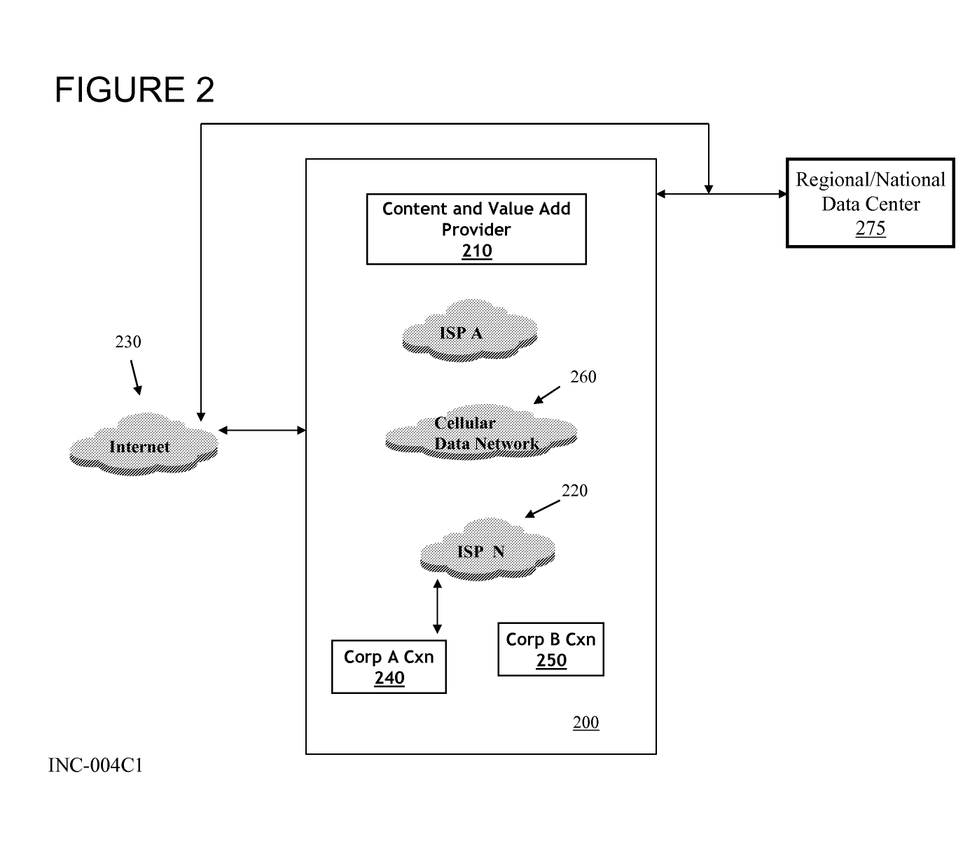

Turning now to FIG. 2, illustrated is a block diagram of an embodiment of a partner/customer network 200 constructed according to the principles of the present invention. The partner/customer network 200 is couplable to a regional/national data center 275 and includes a content and value add provider 210 that provides content and value added services (e.g., credit card validation and physical security monitoring) directed to the partner/customer network 200. The partner/customer network 200 also includes Internet service providers (one of which is designated 220) as well as direct connectivity to the Internet 230. The Internet 230 contemplates a network commonly referred to as the world wide web as well as all the resources and users on the network that employ, for instance, a hypertext transfer protocol or connections employing transmission control protocol/Internet protocol.

The partner/customer network 200 also includes corporate connections referred to as corporate A connection 240 and corporate B connection 250. The corporate A connection 240 is connected through one of the partner networks such as an Internet service provider 220 whereas the corporate B connection 250 is directly coupled to the regional/national data center 275. Those skilled in the art should understand that other network systems and connections may readily exist within the partner/customer network 200. The partner/customer network 200 also includes a cellular network 260 capable of providing, for instance, 2.5 G or 3 G data services. The regional/national data center 275 interfaces with the partner/customer network 200 providing communications to be initiated and terminated between the partner/customer network 200 and a back haul/aggregation network (see FIG. 1). For example, a user connected via the cellular data network 260 may connect directly to a user in the back haul/aggregation network via a multimedia system constructed according to the principles of the present invention.

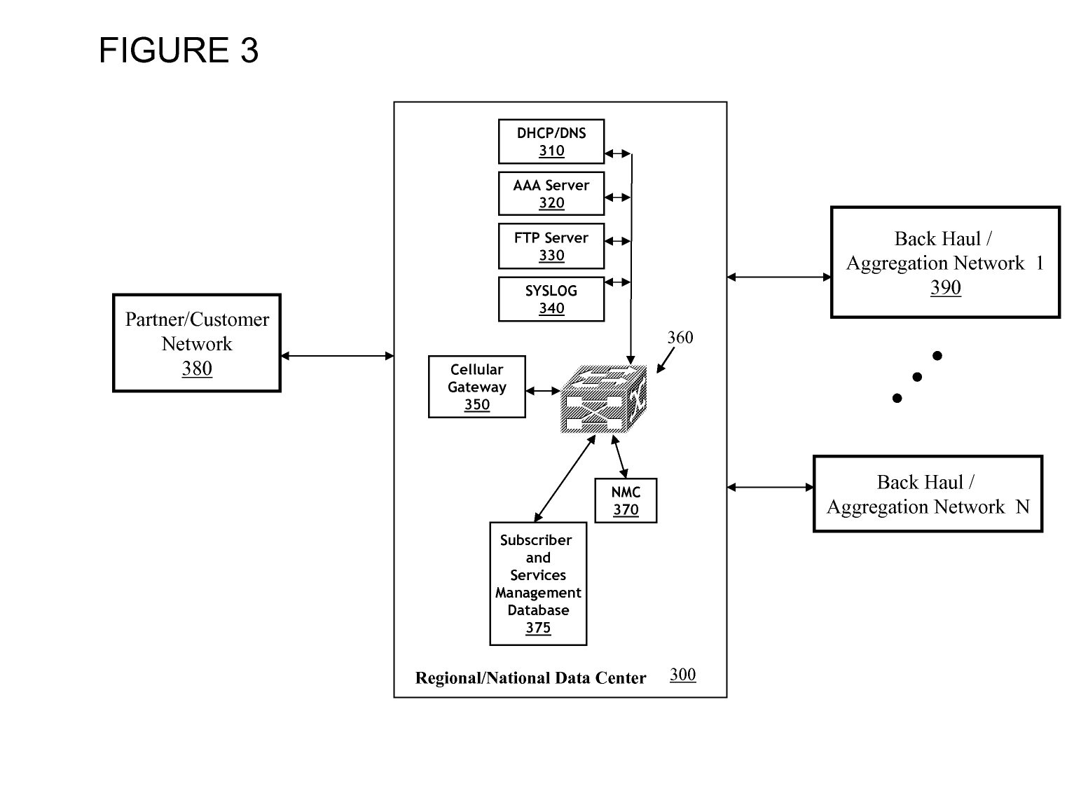

Turning now to FIG. 3, illustrated is a block diagram of an embodiment of a regional/national data center (also referred to as a “data center”) 300 constructed according to the principles of the present invention. The data center 300 is connected to a partner/customer network 380 and a plurality of back haul/aggregation networks (one of which is designated 390). The data center 300 provides a primary controlling functionality for the partner/customer network 380 and the back haul/aggregation networks 390. While a single data center 300 is illustrated in the present embodiment, it is well within the broad scope of the present invention to employ multiple data centers 300. In accordance therewith, multiple data centers 300 may be employed to enhance security and for reliability to provide redundancy associated with the data center 300.

The data center 300 includes a dynamic host configuration protocol and domain name system server (“DHCP/DNS”) 310, an authentication, authorization, and accounting server (“AAA Server”) 320, a file transfer protocol server (“FTP Server”) 330, and a system log (“SYSLOG”) 340. The data center 300 also includes a cellular gateway 350, a main router/switching function 360, a network management center (“NMC”) 370, and a subscriber and services management database 375. Of course, other systems such as security systems and virtual private networks are also typically employed with the data center 300. The connectivity to the data center 300 will typically be via a fiber ring or dedicated fiber lines although wireless connections are also comprehended.

The functionality of the data center 300 includes subscriber and provisioning services, virtual private network functions, security services, content delivery, value added services, quality of service management, traffic shaping and policing, connectivity to the Internet service providers and corporate customers, flow through provisioning, accounting and billing, fault management and fault correlation, performance management and operator security management. The aforementioned functions and methods to implement the functionality are well known in the art.

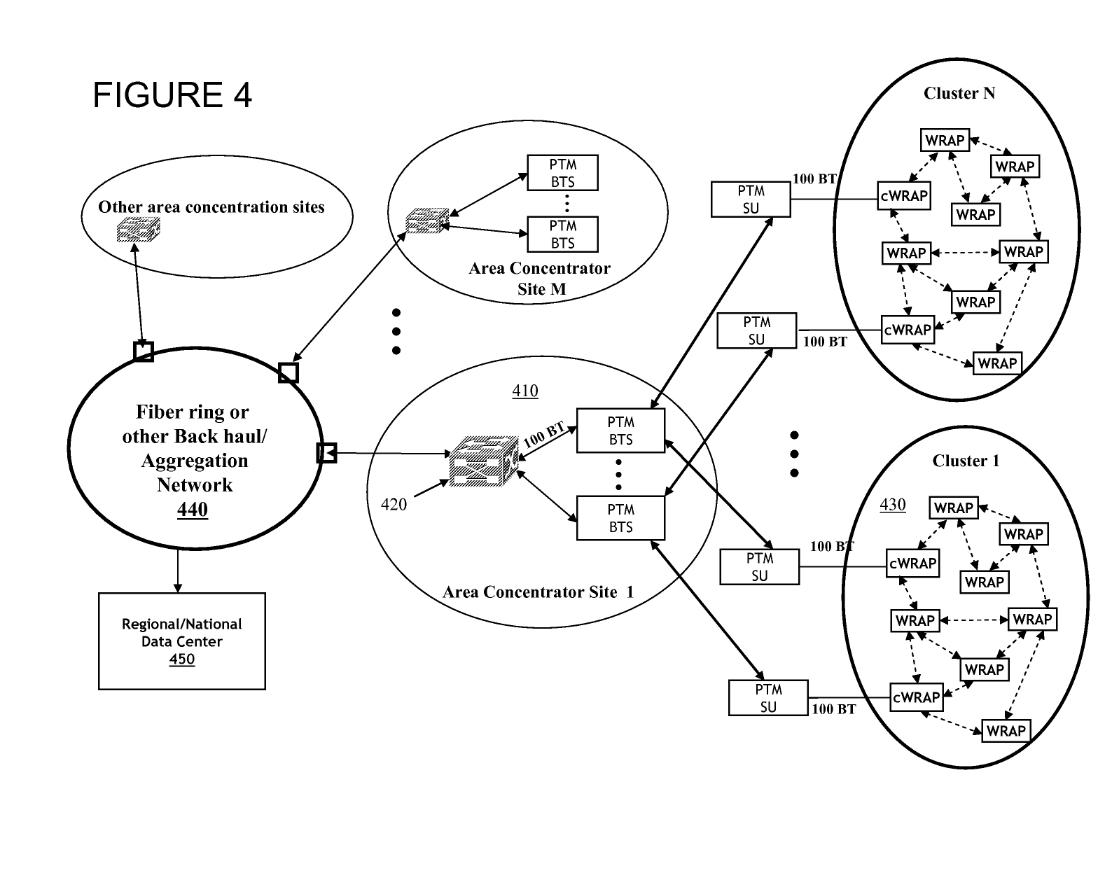

Turning now to FIG. 4, illustrated is a block diagram of an embodiment of a back haul/aggregation network constructed according to the principles of the present invention. The back haul/aggregation network includes at least one area concentrator site (also referred to as an “area concentrator,” of which one is designated 410) connected to a regional/national data center 450 through a fiber ring or other back haul/aggregation network 440 of capacity adequate to support the traffic. The number of deployed area concentrators 410 depends on an amount of total area covered and to a lesser extent on a number of users. A fully deployed network may have area concentrators 410 in the hundreds or even greater.

The area concentrator 410 includes an edge concentrator 420 functioning as a translator/router/switch and as the primary interface to the other back haul/aggregation network 440. The area concentrator 410 also includes a plurality of wireless point-to-multipoint base transceiver systems (designated “PTM BTS”) at distributed locations therein. The point-to-multipoint base transceiver systems PTM BTS may be sectored or configured as full 360 degree units and typically are mounted on relatively high locations such as the top of a building, water tower or existing radio towers, and cover an area with a radius typically from about two to six miles based primarily on a capacity and range capability of the wireless systems.

As an example, the point-to-multipoint base transceiver systems PTM BTS may be embodied in a Proxim Tsunami Multipoint Wireless Ethernet System (hereinafter “Proxim System”). The Proxim System provides from 20 to 60 megabits/sector employing up to six sectors per base station. The Proxim System, and other analogous systems, are capable of wirelessly aggregating the traffic from multiple clusters within the aforementioned two to six mile radius into a single location whereby the traffic can be routed into a larger back haul/aggregation network. While the Proxim System employs a 5725 to 5825 gigahertz unlicensed band, other unlicensed bands or licensed bands may also be employed.

The point-to-multipoint base transceiver systems PTM BTS provide wireless connections to point-to-multipoint subscriber units (designated “PTM SU”), which are coupled to a cluster (one of which is designated 430). The clusters 430 have two connections to the point-to-multipoint base transceiver systems PTM BTS for redundancy such that there is no single point failure between any cluster 430 and the area concentrator 410. While only two clusters 430 are shown, the number of clusters 430 served by an area concentrator 410 can vary from at least one to a multitude (e.g., 50 to 75) of clusters 430 depending upon demographics and topographies. In the illustrated embodiment, the clusters 430 are designed to be located at specific areas of high user traffic such as strip shopping malls, commercial areas where shops and other places of business are located, commercial parks, or multiple dwelling units. The specific number of clusters 430 as well as the size thereof may vary depending on the size and concentration of covered establishments.

Regarding the structure, the clusters 430 include a multimedia system formed by wireless router access points (designated as “WRAPs”), concentrator wireless router access points (designated as “cWRAPs”) and cluster feeders (not shown). The wireless router access points WRAPs and the concentrator wireless router access points cWRAPs form a mesh network of individual point-to-multipoint access points (e.g., 802.11 access points) to a well defined area designated as the cluster 430. In the context herein, reference to 802.11 refers to any 802.11 based communication protocol and service as promulgated by the Institute of Electrical and Electronic Engineers. Specifically, the 802.11 type wireless local area network service is offered to individual users in this manner. The clusters 430 need not be contiguous, but exist where justified due to traffic and density of users and business establishments.

Within the cluster 430 is at least one concentrator wireless router access point cWRAP. The concentrator wireless router access point cWRAP is basically a wireless router access point WRAP with additional control capability to collect traffic to and from the wireless router access points WRAPs and to connect to the point-to-multipoint subscriber units PTM SUs. Multiple concentrator wireless router access points cWRAPs are often used for redundancy to eliminate single point failures at this junction. The remaining area of the cluster 430 is generally serviced with wireless router access points WRAPs and also cluster feeders. The specific number of wireless router access points WRAPs, concentrator wireless router access points cWRAPs and cluster feeders to support a cluster 430 generally depends on the area of the cluster 430, the specific geometry of the cluster 430 as related to density and obstacles, and the traffic load of the cluster 430. While the service to be offered to users is generally 802.11b, the principles of this invention are equally applicable to other existing, improved, enhanced and new versions of 802.11 (e.g., 802.11a, 802.11g) as well as other point-to-multipoint services based on other wireless standards consistent with physical propagation, federal communication commission specifications, and interference within the cluster 430.

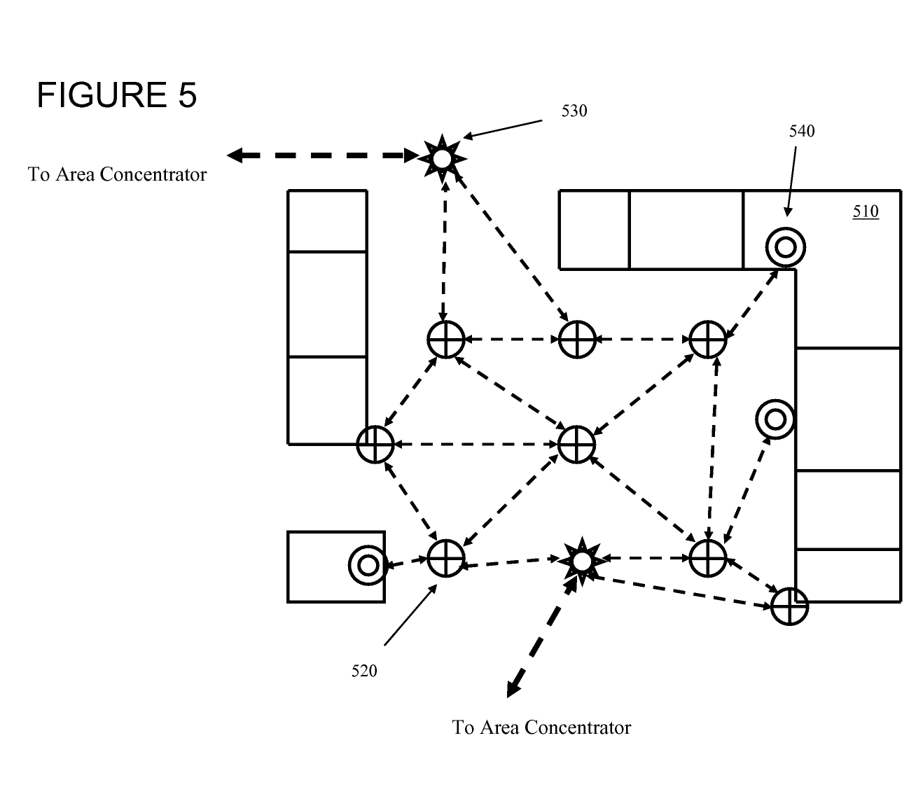

Turning now to FIG. 5, illustrated is a block diagram of an embodiment of a cluster constructed according to the principles of the present invention. The cluster is in the proximity of a strip shopping center including a plurality of commercial establishments (one of which is designated 510) in which users employ wireless devices. Of course, the number of commercial establishments 510 may vary from cluster to cluster and will typically be from as few as one to 50 or more. Also, the clusters may be contiguous such that a number of commercial establishments 510 covered within any local geographic area is unlimited. The size of a cluster is primarily determined by the density of commercial establishments 510 therein as well as the propagation properties of the point-to-multipoint service (e.g., a 802.11 service) and the local mesh connectivity. It is also understood that the number of mesh connections is not unbounded due to the finite number of hops allowed by the mesh architectures and the amount of latency allowed within the network. All the elements together influence the actual cluster sizes to be typically on the order of hundreds of meters across. The aforementioned distances are adequate for most local commercial concentrations.

The cluster includes a multimedia system designed for the purpose of providing a customer interface, establishing interconnecting mesh communications and connecting to an area concentrator (see FIG. 4). The multimedia system of the cluster includes wireless router access points (one of which is designated 520), concentrator wireless router access points (one of which is designated 530 and cluster feeders (one of which is designated 540) coupled together via wireless mesh connections. The wireless router access points 520 and the concentrator wireless router access points 530 are typically located external to the commercial establishments 510 and may be mounted on light poles, fixed structures such as signs, or the edges of buildings. Any permanent mount with a point-to-multipoint access to the commercial establishments 510 or the cluster feeders 540 is a suitable location for mounting the wireless router access points 520 or the concentrator wireless router access points 530.

In general, a wireless router access point 520 is wirelessly connected to other wireless router access points 520 or concentrator wireless router access points 530 to which a wireless mesh interface can be established. In the event of a single wireless router access point 520 failure, the mesh network will realign and the integrity of the rest of the network will be maintained. As a result, a cluster does not experience catastrophic failure due to a single point failure with a wireless router access point 520. It should be understood, however, that a wireless router access point 520 can connect with any wireless router access point 520 or concentrator wireless router access point 530 wherein a wireless connection can be established. As mentioned above, the concentrator wireless router access points 530 are basically wireless router access points 520 with additional control capabilities to act as traffic concentrators for the cluster. The concentrator wireless router access points 530 are also prime connection points to an area concentrator. While at least one concentrator wireless router access point 530 is located in each cluster, additional concentrator wireless router access points 530 may be included in a cluster to handle higher traffic and to provide redundancy therein.

The cluster feeders 540 act in a bridging or “gap-filling” fashion to provide point-to-multipoint coverage to areas of the cluster that are not directly accessible by the wireless router access points 520 or the concentrator wireless router access points 530. Due to the geometry or other factors of the commercial establishment 510, a cluster may need a significant number of cluster feeders 540, whereas other clusters may not need any cluster feeders 540. The cluster feeders 540 may be externally mounted or internally mounted with respect to the commercial establishment 510.

A multimedia system according to the principles of the present invention embodied in the cluster provides an architecture that delivers reliable point-to-multipoint services (e.g., 802.11 services) to users in an area of commercial establishments 510. The architecture integrates a natural back haul redundancy with the ability to add wireless router access points 520, concentrator wireless router access points 530 and cluster feeders 540 for the purpose of adding capacity and improving coverage integrity. The mesh interconnection among the wireless router access points 520 and the concentrator wireless router access points 530 allows for a self management network loading and substantially eliminates the need for extensive network planning prior to initial installation of a network and complex replanning due to changing traffic patterns within the cluster. Exemplary features of the architecture include fail soft functionality, ease of adding wireless router access points 520 and therefore cluster capacity, and efficient routing of traffic within the cluster.

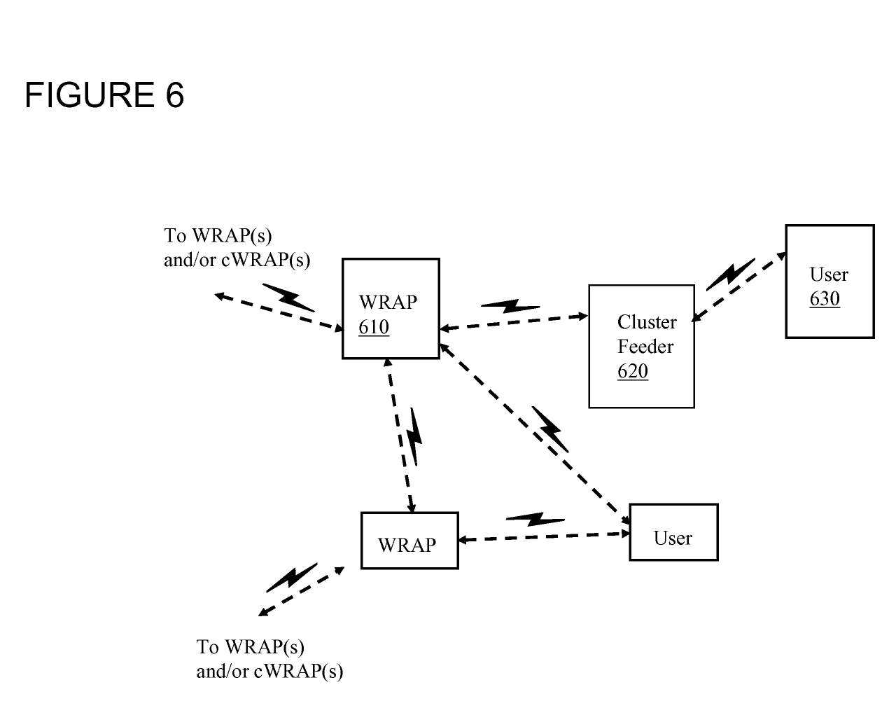

Turning now to FIG. 6, illustrated is a block diagram of an embodiment of portions of a cluster constructed according to the principles of the present invention. The cluster includes a multimedia system having a plurality of wireless router access points (one of which is designated 610), which may also be concentrator wireless router access points as described above. The wireless router access points 610 communicate with other wireless router access points 610, concentrator wireless router access points (not shown), cluster feeders 620 or users (one of which is designated 630), either directly or indirectly. While only a small number of components are illustrated in the cluster, those skilled in the art should understand that many components may be deployed with the cluster as the application dictates.

The wireless router access points 610 connect to other wireless router access points and the concentrator wireless router access points via a mesh network. The wireless router access points 610 connect to the cluster feeder via the mesh network or a point-to-multipoint network (e.g., a 802.11 network). The wireless router access points 610 connect to the users 630 via the point-to-multipoint network. The cluster feeder 620, which may be internally or externally mounted, provides a bridging connection between a user 630 and the mesh network to improve indoor or blocked coverage therefor. Without the cluster feeders 620, the user 630 may have no connection or a poor connection to the mesh network. The cluster feeders 620 enable a user 630 to be connected or allow a highly localized area to be covered that would otherwise be unavailable. The user 630 represents a wireless device (e.g., as a personal digital assistant or laptop computer), a desktop computer, a router, a switch, a hub or similar device with connectivity to multiple versions of the above.

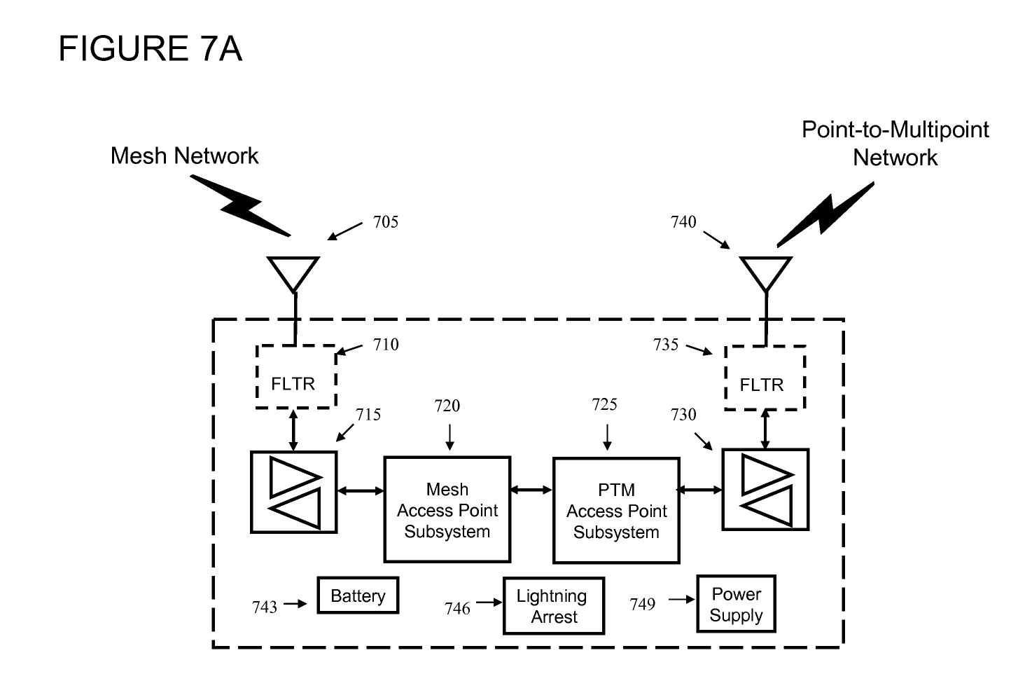

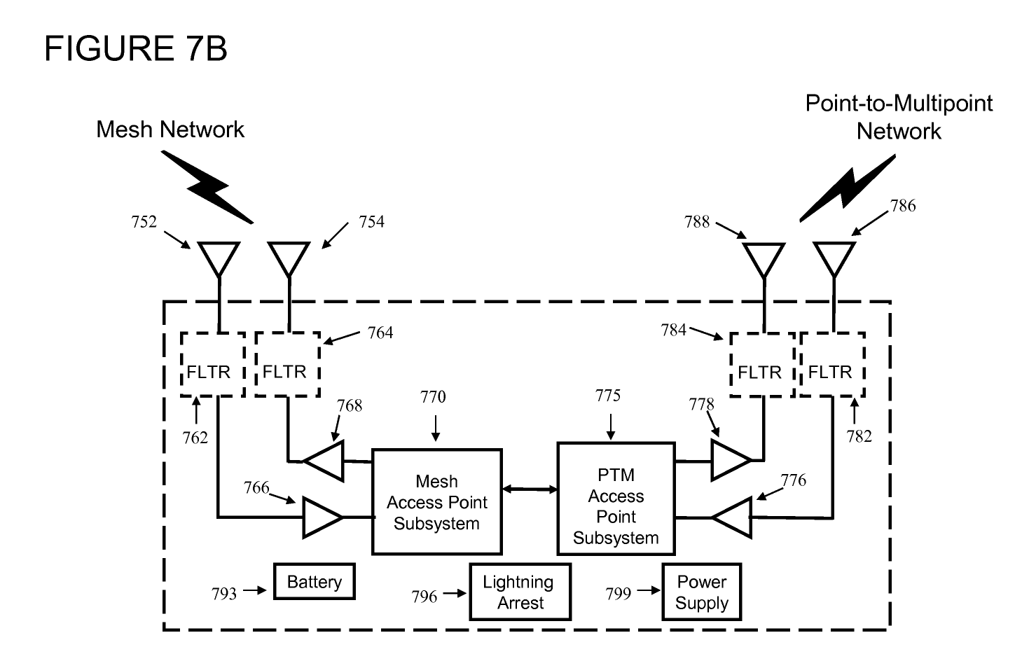

Turning now to FIGS. 7A and 7B, illustrated are block diagrams of alternative embodiments of a wireless router access point constructed according to the principles of the present invention. The wireless router access point provides seamless connectivity between a mesh network employing a mesh protocol and a point-to-multipoint network such as a wideband fidelity (“WiFi”) network [e.g., 802.11(a), 802.11(b) or 802.11(g)] or wideband maximum (“WiMax”) network (e.g., 802.16 network) employing a point-to-multipoint protocol such that user services can be provided without the networks interfering with one another.

As hereinafter discussed, the wireless router access point includes a mesh access point subsystem and a point-to-multipoint access point subsystem. The mesh access point subsystem translates between the point-to-multipoint protocol and the mesh protocol to communicate with the mesh network. The point-to-multipoint access point subsystem translates between the mesh protocol and the point-to-multipoint protocol to communicate with the point-to-multipoint network. Additionally, there are a wide variety of radio protocols at different frequencies that might be used for the mesh network operating in the cluster. If the same frequencies are used in the mesh network as the radio from the wireless access points (or repeater) to the user, radio interference and traffic congestion may be an issue. Using a higher bandwidth technology for the mesh network than for the point-to-multipoint network provides a better opportunity for better throughput to the users.

A bi-directional wireless router access point is illustrated in FIG. 7A wherein a connection to a mesh network is made via a mesh antenna 705 (i.e., to communicate with the mesh network), which is coupled to a mesh conditioning input/output filter 710. The mesh antenna 705 transmits and receives signals to and from the mesh network. For reception, the mesh conditioning input/output filter 710 rejects (or filters) out-of-band signals which, if not present, could saturate a front end of the wireless router access point that processes the signals from the mesh network (i.e., a mesh transceiver) thereby reducing the incoming signal to noise ratio. For transmission, the mesh conditioning input/output filter 710 assures that out of band transmissions do not exceed the specifications of any appropriate standard for that band. For some applications, the aforementioned functionality may be adequately provided by other components of the wireless router access point (or network in general) and, as a result, the mesh conditioning input/output filter 710 may not be necessary.

An output of the mesh conditioning input/output filter 710 is coupled to a mesh bi-directional amplifier 715, which amplifies signals for a mesh access point subsystem 720 associated with the mesh network. The mesh access point subsystem 720 includes communication circuitry and control elements normally associated with an access point for a mesh network. The mesh access point subsystem 720 provides functionality that allows the wireless router access point to communicate with other wireless router access points in a cluster. The mesh access point subsystem 720 is coupled to a point-to-multipoint access point subsystem (also referred to as a “PTM access point subsystem;” e.g., a 802.11 access point subsystem) 725 employing, for instance, a transmission control protocol/Internet protocol. The point-to-multipoint access point subsystem 725 provides functionality for servicing users over a point-to-multipoint network such as a 802.11 network directly or via cluster feeders as described above. The point-to-multipoint access point subsystem 725 is coupled to a point-to-multipoint bi-directional amplifier 730, which is coupled to a point-to-multipoint conditioning input/output filter 735 and a point-to-multipoint antenna 740. The point-to-multipoint bi-directional amplifier 730, the point-to-multipoint conditioning input/output filter 735 and the point-to-multipoint antenna 740 provide amplification, filtering and interface functions to the point-to-multipoint network. The wireless router access point is contained within an environmental case and also includes other ancillary support subsystems such as a battery 743 (for battery back-up power), protection subsystems (for system protection functionality such as a lightning arrestor 746), and a power conditioning supply 749 (for conditioning the power to operate the wireless router access point).

Another embodiment of a wireless router access point is illustrated in FIG. 7B in which separate transmit and receive paths are maintained for a mesh access point subsystem 770 and a point-to-multipoint access point subsystem (also referred to as a “PTM access point subsystem;” e.g., a 802.11 access point subsystem) 775. A connection to a mesh network is made via a mesh receive antenna 752 (for receiving signals from the mesh network), which is coupled to a mesh receive conditioning filter 762 (for filtering the signals) and a mesh receive amplifier 766 (for amplifying the signals). The mesh receive amplifier 766 is coupled to the mesh access point subsystem 770. With respect to a mesh transmission path, the mesh access point subsystem 770 provides an input to a mesh transmit amplifier 768 which amplifies signals for a mesh transmit conditioning filter 764 that filters the signals for a mesh transmit antenna 754, which transmits the signals to the mesh network.

A connection is made to the point-to-multipoint network such as a 802.11 network via a point-to-multipoint receive antenna 786 (for receiving signals from the point-to-point network), which is coupled to a point-to-multipoint receive conditioning filter 782 (for filtering the signals) and a point-to-multipoint receive amplifier 776 (for amplifying the signals). The point-to-multipoint receive amplifier 776 is coupled to the point-to-multipoint access point subsystem 775. With respect to the point-to-multipoint transmission path, the point-to-multipoint access point subsystem 775 provides an input to a point-to-multipoint transmit amplifier 778 which amplifies signals for a point-to-multipoint transmit conditioning filter 784 that filters signals for a point-to-multipoint transmit antenna 788. The wireless router access point is contained within an environmental case and also includes other ancillary support subsystems such as a battery 793 (for battery back-up power), protection subsystems (for system protection functionality such as a lightning arrestor 796), and a power conditioning supply 799 (for conditioning the power to operate the wireless router access point).

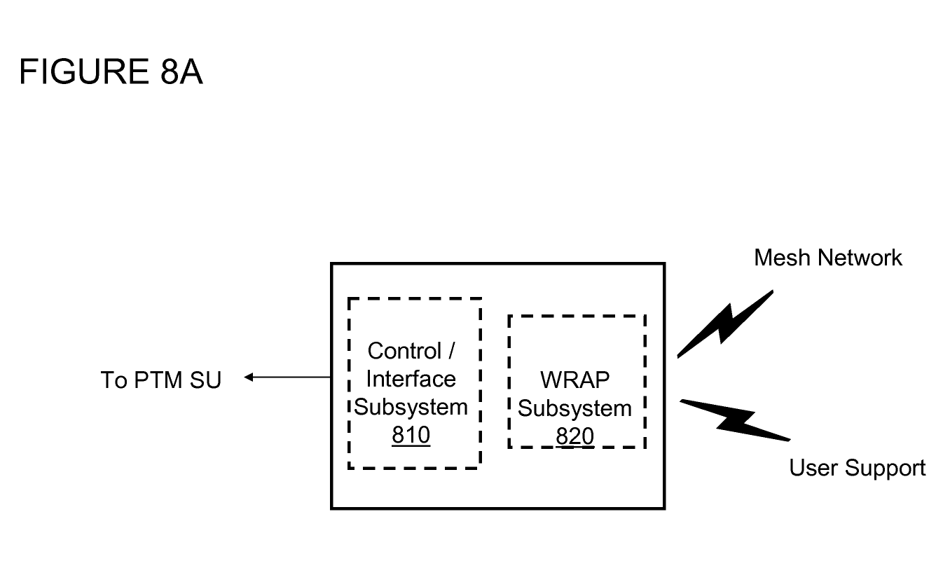

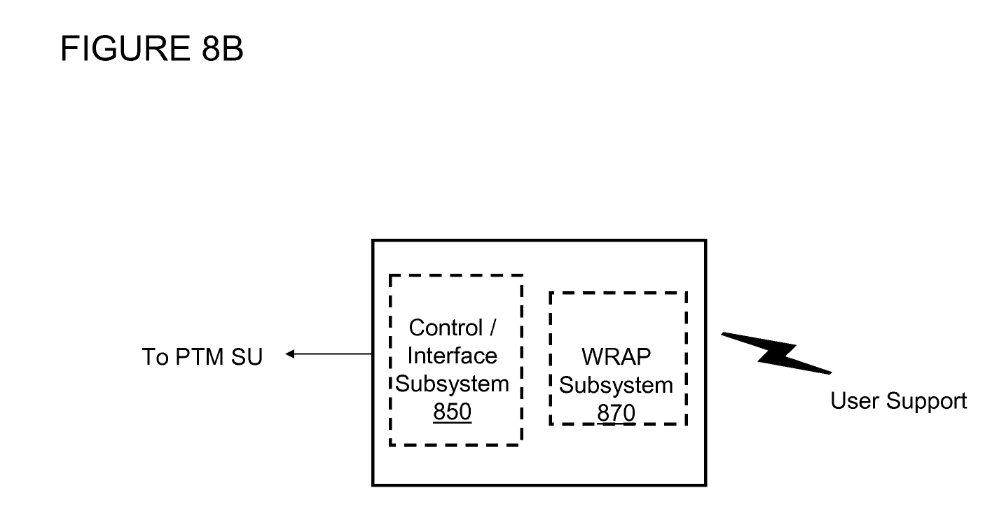

Turning now to FIGS. 8A and 8B, illustrated are block diagrams of alternative embodiments of a concentrator wireless router access point constructed according to the principles of the present invention. The concentrator wireless router access point communicates within a back haul/aggregation network as illustrated and described with respect to FIG. 4. As described above, each cluster typically contains at least one and typically two concentrator wireless router access points for the purpose of maintaining a redundant connection within the back haul/aggregation network. This feature provides for a reliable and less complex connection to an area concentrator while simultaneously providing user support.

Referring to FIG. 8A, a concentrator wireless router access point is embodied in a single enclosure and includes a control/interface subsystem 810 and a wireless router access point subsystem (also referred to as a “WRAP subsystem”) 820 analogous to the wireless router access point illustrated and described with respect to FIGS. 7A and 7B. The wireless router access subsystem 820 provides a wireless interface and functionality to communicate with wireless router access points and concentrator wireless router access points via a mesh network and provides point-to-multipoint support to users within a selected range. The control/interface subsystem 810 provides control functions to manage the multiple wireless router access points and provides an interface (e.g., a wired interface) to a point-to-multipoint subscriber unit (also referred to as a “PTM SU”) as described above, which is part of a back haul/aggregation network.

Referring to FIG. 8B, illustrated is an alternative embodiment of a concentrator wireless router access point that includes a wireless router access point subsystem (also referred to as a “WRAP subsystem”) 870 with a point-to-multipoint access point subsystem to provide user support. A control/interface subsystem 850 of the concentrator wireless router access point provides analogous functionality as described with respect to FIG. 8A above. The concentrator wireless router access point interfaces with a point-to-multipoint subscriber unit (also referred to as a “PTM SU”) back haul/aggregation network without interfacing with other wireless router access points. One useful application of this configuration is for isolated areas of a cluster.

While the wireless router access points and the concentrator wireless router access points have been described with respect to a single structure, it is well within the broad scope of the present invention to separate portions thereof into multiple units coupled together via, for instance, wired connections. For example, a mesh access point subsystem and the related components may be mounted in an enclosure at a different location of a site embodying the wireless router access point or the concentrator wireless router access point from the point-to-multipoint access point subsystem and connected via a wired connection. In any event, a physical separation of the respective subsystems does not detract from the concepts discussed above.

Furthermore, the antennas referenced above with respect to the illustrated embodiments include single elements for clarity. It is fully comprehended, however, that an antenna function may also consist of multiple elements configured to achieve diversity wherein a plurality of antennas are configured to be of sufficient number of wavelengths apart, usually around ten, or of different polarities so that the signals to and from an element are decorrelated from that of another. For those cases where diversity is employed, the transceiver function of the wireless router access points is employable therewith. In addition to diversity, different polarizations such as horizontal, vertical, or circular may be employed to improve a performance of the wireless router access points and the concentrator wireless router access points in specific conditions usually related to multipath or interference conditions.

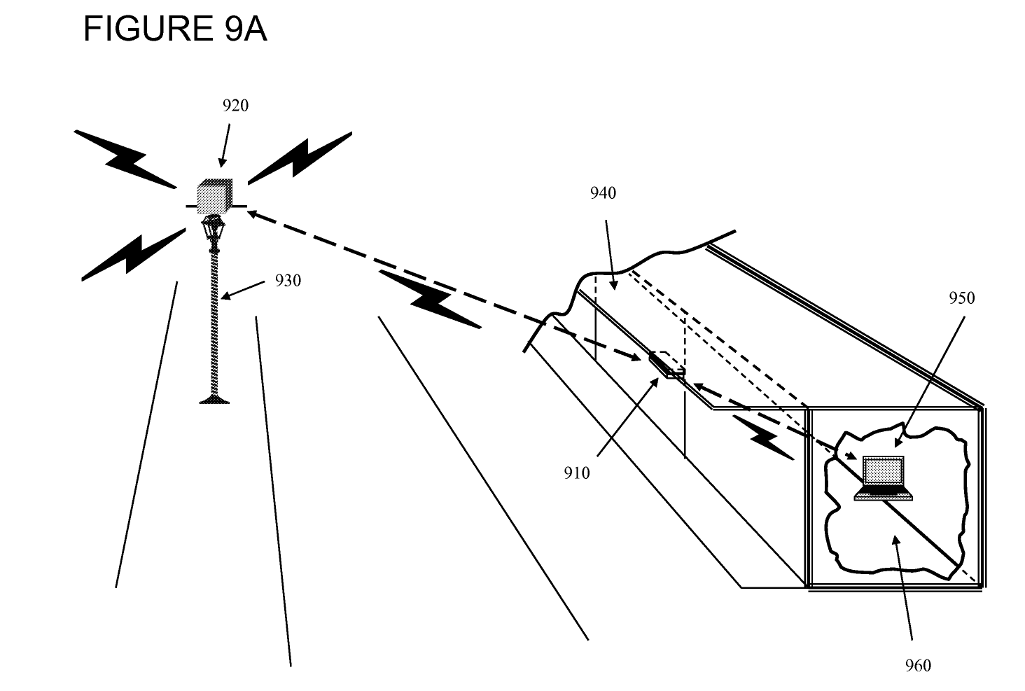

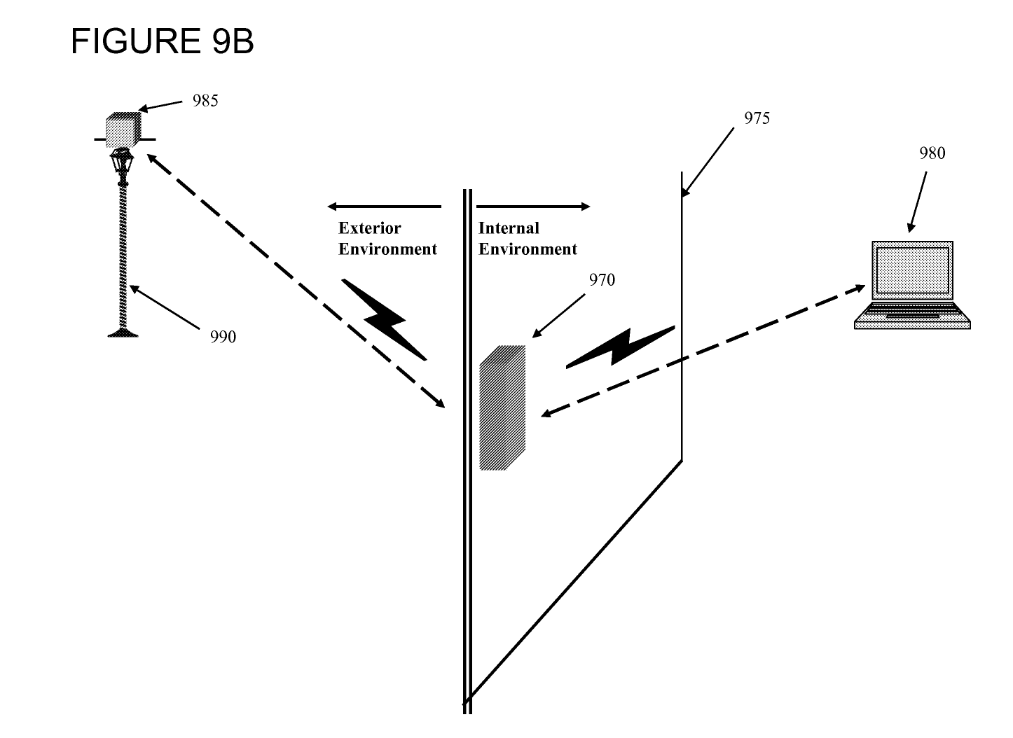

Turning now to FIGS. 9A and 9B, illustrated are diagrams of alternative configurations for cluster feeders constructed according to the principles of the present invention. The cluster feeders allow a user, within a commercial establishment or the like, to reliably connect with a wireless router access point or concentrator wireless router access point when a propagation path therebetween may be insufficient for directly establishing a reliable connection. In other words, the cluster feeder may be incorporated into the multimedia system to facilitate a reliable two-way communications path.

Referring to FIG. 9A, illustrated is an embodiment of a cluster feeder 910 mounted in an external environment. The cluster feeder 910 communicates with a wireless router access point 920 (which may also be a concentrator wireless router access point) mounted to a suitable external supporting structure 930 such as a light pole. Obviously, other external supporting structures may be employed and still be within the broad scope of the present invention. Due to an obstacle (e.g., a physical obstruction such as an overhang) 940, a direct communication link between the wireless router access point 920 and a user (e.g., a computer) 950 located within a commercial establishment 960 is obstructed and unreliable. The cluster feeder 910 is added to the communication path and acts as a bridging device resulting in a reliable link. The cluster feeder 910 can simultaneously establish a communications path to the user 950 and to the wireless router access point 920. Therefore, the external cluster feeder 910 facilitates a reliable communications path between the wireless router access point 920 and the user 950. While the obstacle 940 within the communications path is an overhang in the illustrated embodiment, other obstacles may also prevent a reliable communications link between a user 950 and a wireless router access point 920.

Turning now to FIG. 9B, illustrated is an alternative embodiment of a cluster feeder 970 located in an internal environment. The cluster feeder 970 is attached to a window or other reasonably radio frequency transparent medium 975. The cluster feeder 970 provides a reliable communications path to an internal user 980, even if the user 980 is obscured from an externally mounted wireless router access point 985 (or a concentrator wireless router access point) mounted on an external structure 990. Therefore, the cluster feeder 970 provides a reliable communications path between the wireless router access point 985 and the user 980. In addition to providing a reliable communications link, the internal cluster feeder 970 may serve as an advertising medium telling users that a broadband multimedia services are readily available within a commercial establishment such as restaurants and coffee shops.

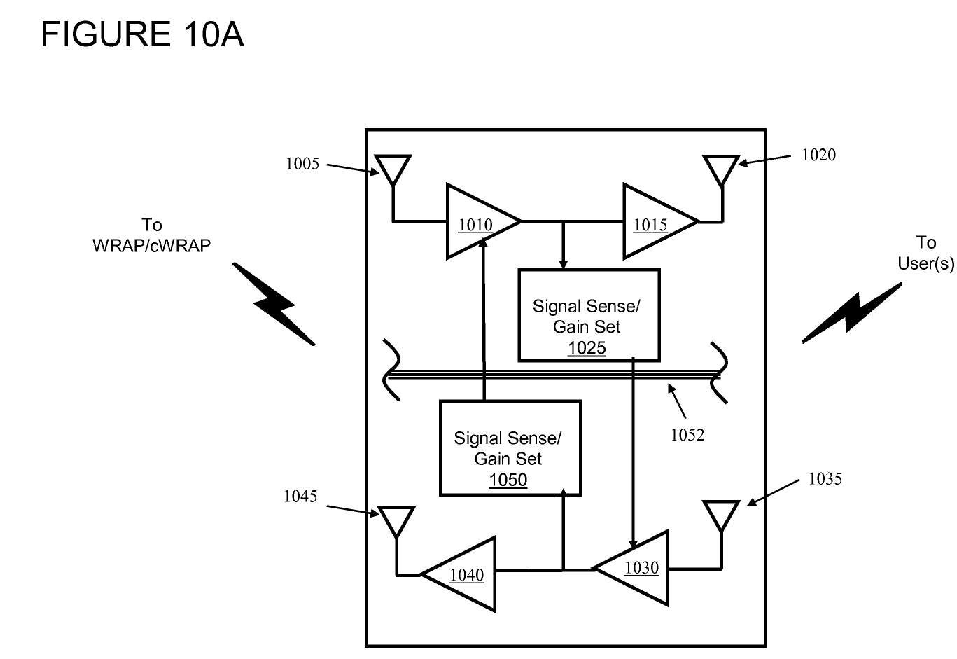

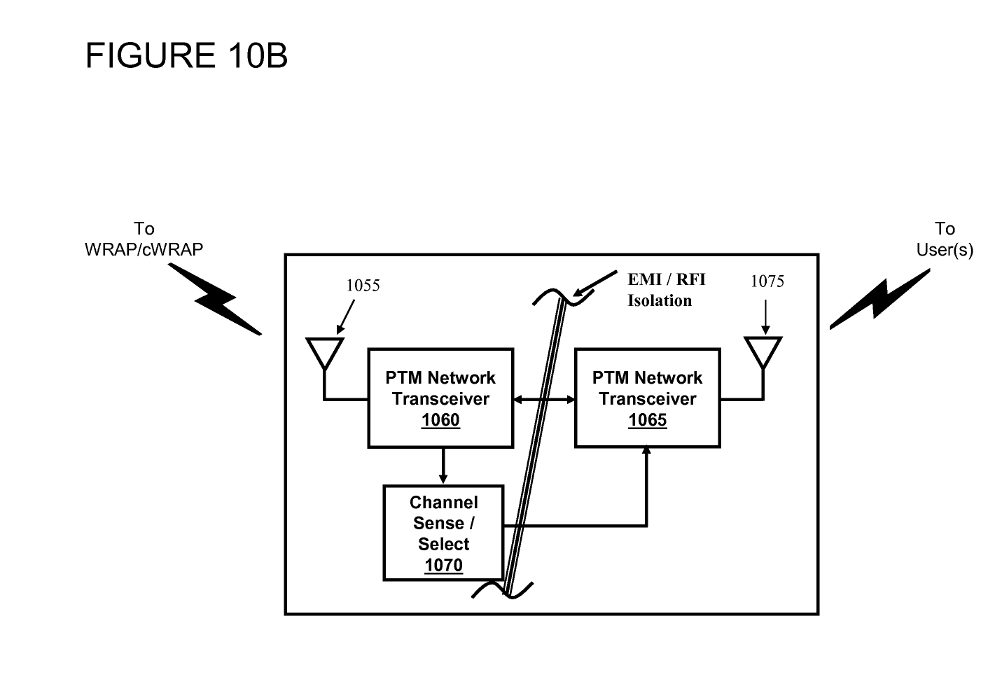

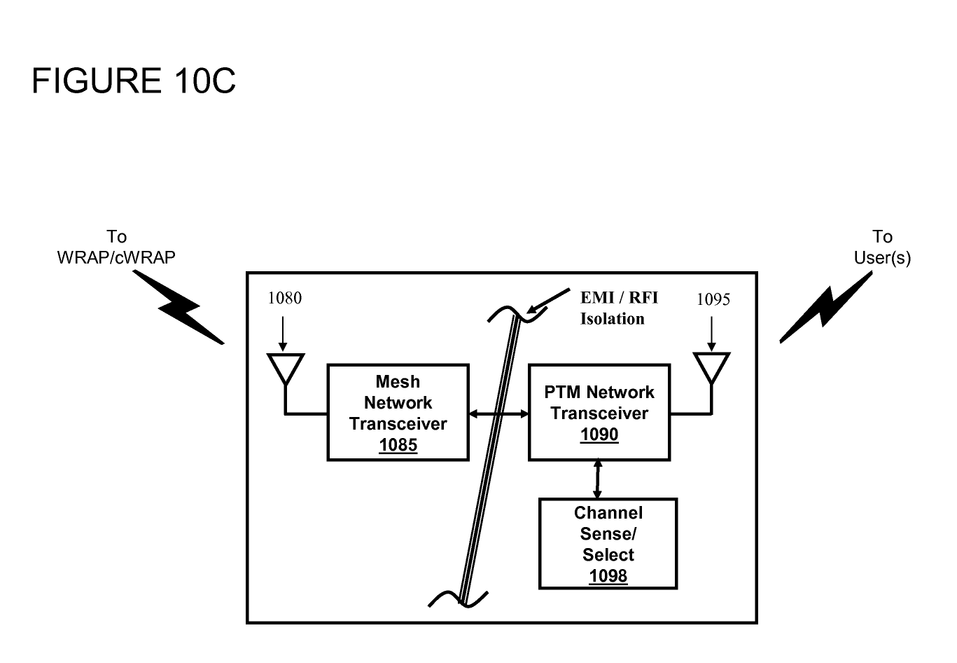

Turning now to FIGS. 10A, 10B and 10C, illustrated are block diagrams of alternative embodiments of a cluster feeder constructed according to the principles of the present invention. The cluster feeder illustrated in FIG. 10A is embodied in a single structure and employs a bi-directional amplifier architecture. Ancillary components such as, but not limited to, mounting hardware and power conditioning systems are not shown for simplicity. A first antenna 1005 accepts a signal employing a point-to-multipoint protocol that is amplified by first and second amplifiers 1010, 1015 with the amplified signal being relaunched by a second antenna 1020. The output of first amplifier 1010 is sampled by a signal sense and gain set module 1025 which reduces the gain of a third amplifier 1030 in the presence of signal incident at the first antenna 1005. In this manner, harmful positive feedback is substantially eliminated.

In the same manner, a third antenna 1035 accepts a signal employing a point-to-multipoint protocol that is amplified by the third amplifier 1030 and a fourth amplifier 1040 with the amplified signal being relaunched by a fourth antenna 1045. Further, an output of the third amplifier 1030 is sampled by another signal sense and gain module 1050 which reduces the gain of the first amplifier 1010 in the presence of signal incident at the third antenna 1020 and thus substantially eliminates harmful positive feedback in the reverse direction as well. A radio frequency barrier 1052 is provided to substantially eliminate harmful crosstalk and isolate the two signal paths.

Referring to FIG. 10B, illustrated is an alternate embodiment of a cluster feeder embodied in a single structure and including a bi-directional translating system. Incoming and outgoing signals employing a point-to-multipoint protocol from a wireless router access point or a concentrator wireless router access point are input to and output from a first antenna 1055. In this manner, communication is established to a cluster as described above. A first point-to-multipoint network transceiver (also referred to as “PTM network transceiver”) 1060 is connected to the first antenna 1055 and includes two other primary interfaces, namely, a connection to a second point-to-multipoint network transceiver (also referred to as “PTM network transceiver”) 1065 and a connection to a channel sense and select module 1070.

The channel sense and select module 1070 determines a channel selected by the first PTM network transceiver 1060 and selects a quality substantially non-interfering channel to be used by the second PTM network transceiver 1065. A typical method for performing the aforementioned function is to employ a look-up table, however, other approaches are valid and fall within the broad scope of the present invention. The second point-to-multipoint network transceiver 1065 interfaces with a second antenna 1075 to provide wideband coverage within a single or small concentrated environment of users such as, but not limited to, an office, restaurant, or apartment.

Referring to FIG. 10C, illustrated is yet another alternative embodiment of a cluster feeder embodied in a single structure and including a bi-directional translating system. The cluster feeder may be referred to as a mini-wireless router access point (also referred to as a “mini-WRAP”) because the cluster feeder includes the basic functionality of a wireless router access point configured to support an environment with a single or small concentration of users such as, but not limited to, an office, restaurant, or apartment.

A first antenna 1080 connects to a mesh network transceiver 1085 and thereby establishes a communication link with a cluster via a mesh network. The mesh network transceiver 1085 is connected to a point-to-multipoint network transceiver 1090, which provides a primary interface to provide wideband coverage to a single or small group of users via signals launched from and received by a second antenna 1095. A channel sense and select module 1098 of the channel feeder selects a quality substantially non-interfering channel to be used by point-to-multipoint network transceiver 1090. One method of performing the aforementioned function is to have the point-to-multipoint network transceiver 1090 survey all available channels and provide both existence and relative strength to the channel sense/select module 1098. Then, via a decision tree or look-up table, the quality channel is selected and communicated to the point-to-multipoint network transceiver 1090.

In yet another embodiment, a cluster feeder may be embodied in a point-to-multipoint repeater, whereby packets are received and transmitted according to an appropriate point-to-multipoint specification across a cluster feeder boundary. While the present embodiments of the cluster feeders are disclosed in a single structure, it should be understood that portions of the cluster feeders may be separated into multiple units connected via, for instance, a wired connection. For example, portions of the cluster feeders that perform external communicating functions may be mounted at a different location from the portions of the cluster feeder that perform internal communicating functions. In any event, a physical separation of the respective subsystems of the cluster feeders does not detract from the concepts discussed above.

Furthermore, the antennas referenced above with respect to the illustrated embodiments include single elements for clarity. It is fully comprehended, however, that an antenna function may also consist of multiple elements configured to achieve diversity wherein a plurality of antennas are configured to be of sufficient number of wavelengths apart, usually around ten, or of different polarities so that the signals to and from an element are decorrelated from that of another. For those cases where diversity is employed, the transceiver function of the cluster feeders is employable therewith. In addition to diversity, different polarizations such as horizontal, vertical, or circular may be employed to improve a performance of the wireless router access points and the concentrator wireless router access points in specific conditions usually related to multipath or interference conditions.

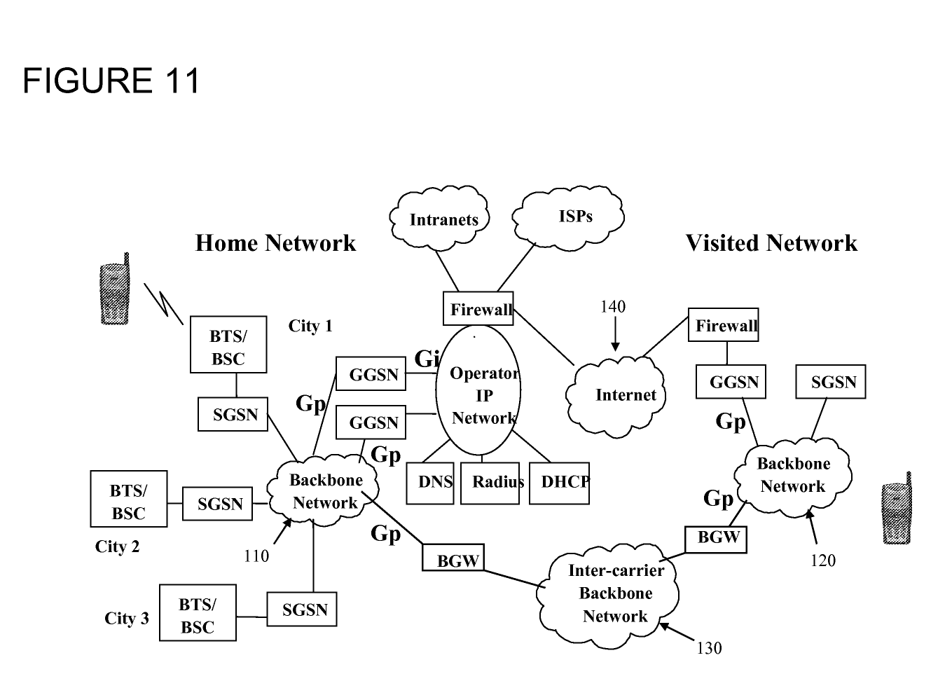

Turning now to FIGS. 11 to 13, illustrated are block diagrams of alternative embodiments of wireless networks, or portions thereof, that provide an environment for an application of a multimedia system constructed according to the principles of the present invention. In the present embodiment, a general packet radio service network architecture is illustrated and hereinafter described. Those skilled in the art should understand, however, that other wireless networks such as an enhanced data rates for global evolution network or a single carrier radio transmission technology compatible network are well within the broad scope of the present invention.

By way of background, the complexity of most enterprise applications has led to confusion, misunderstanding, and skepticism within the information technology departments of organizations and among potential users. Many mobile enterprise applications have failed to meet the expectations of the organizations or the users because the applications failed to operate properly, and the applications were not robust or reliable. With the proper network architecture, however, many of the shortcomings can be overcome. Whether the application is field force automation, fleet management and dispatch, or intranet access for mobile employees, there are three key attributes that are almost uniformly necessary for success, namely, coverage, security, and cost-effectiveness, which are not mutually exclusive.

For instance, the amount and type of coverage and the performance of the network within a coverage area will drive the cost of the network and the resulting price of the access service. Also, the way in which the security is provided can significantly impact the cost of the service and the ease of use by the mobile workers. To achieve a balance that provides good network coverage with good throughput and performance, an integrated approach using a wireless local area network for broadband access in high-density areas and the general packet radio service network for medium bandwidth access across a wide coverage area is believed to provide a robust solution. Transparent mobility between similar networks is very complex and may become more difficult when mobility between different types of networks is desired.

Referring to FIG. 11, a general packet radio service network is illustrated that supports roaming between a home general packet radio service network (also referred to as a “home network”) and a visited general packet radio service network (also referred to as a “visited network”). A key interface between the home and visited networks is a path between home and visited backbone networks 110, 120 and border gateways (generally designated “BGW”) thereof through a inter-carrier backbone network 130. The border gateway is a router supporting an exterior routing protocol (such as a border gateway protocol like BGP-4) employable to perform route selection between autonomous systems. The border gateway supports inter-working and resolves compatibility issues between equipment from different vendors. Consumer mobile data access to the Internet 140 can be routed through a gateway general packet radio service network support node (generally designated “GGSN”) in the visited network directly to a desired Internet service provider (generally designated “ISP”) and the visited network collects charging information via call detail records. When a mobile enterprise customer using a virtual private network for security roams and experiences a handoff, the session should be maintained through the home network.

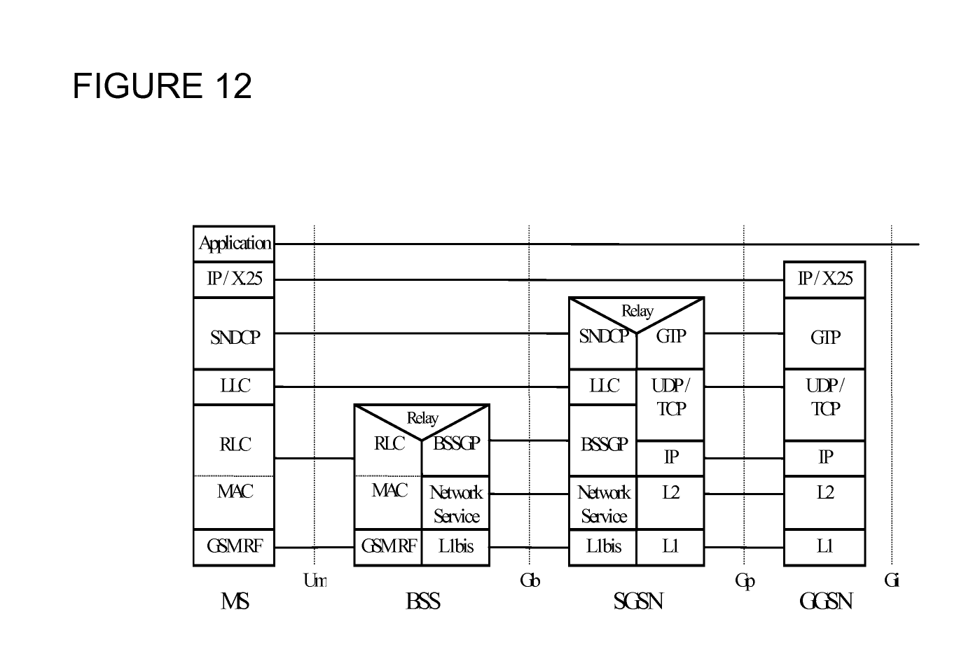

Referring to FIG. 12, illustrated is a general packet radio transmission plane architecture that includes a multi-layered protocol stack. Layers one and two of the multi-layered protocol stack have not been defined within the standard, allowing operators entering into roaming agreements to define and agree upon. The network layer (i.e., layer three) is an Internet protocol (generally designated “IP”) and is currently based on Internet protocol version four. The transport layer (i.e., layer four) can be either user datagram protocol (generally designated “UDP”) or transmission control protocol (generally designated “TCP”) depending on whether a best effort transport or a reliable transport is preferred. With the best effort packet transport (such as the user datagram protocol), no acknowledgment of packet delivery between end points of the backbone network is typically provided.

With the transmission control protocol, packets sent over the network are acknowledged and retransmitted in the case of packet errors or loss, which becomes a very important issue in wireless networks that exhibit fading and other impairments. The transmission control protocol is designed to assure performance in a wired network and actually degrades performance in a wide area wireless network. Layer five introduces a new protocol developed specifically for the general packet radio service network, namely, a general packet radio service tunneling protocol (generally designated “GTP”).

Tunneling is a mechanism for transporting Internet protocol packets between two similar endpoints over an interconnecting but dissimilar network (e.g., an inter-public land mobile network backbone). Tunneling is achieved by encapsulating packets coming from the transmission control protocol/user datagram protocol layer into another packet with a new header including an Internet protocol address. The original packet becomes the payload for the new combined encapsulated packet structure. In addition to solving the potential incompatibilities between the end networks (e.g., general packet radio service networks) and the connecting network (e.g., inter-public land mobile networks), the tunnel also provides a degree of security since the original data packet is not ‘seen’ by the connecting network.

The general packet radio service tunneling protocol carries the user data and signaling between the visited and home networks to support terminal identification and authentication as well as mobility management functions such as general packet radio service attach or detach and packet data protocol context activation and deactivation (i.e., a data session). The general packet radio service tunneling protocol is implemented on a serving general packet radio service support node (generally designated “SGSN”) and the gateway general packet radio service network support node and has little relevance outside of the Gp interface and the Gi interface. The general packet radio service tunneling protocol establishes a tunnel on a demand basis between a connecting general packet radio service support node pair to carry traffic therebetween.

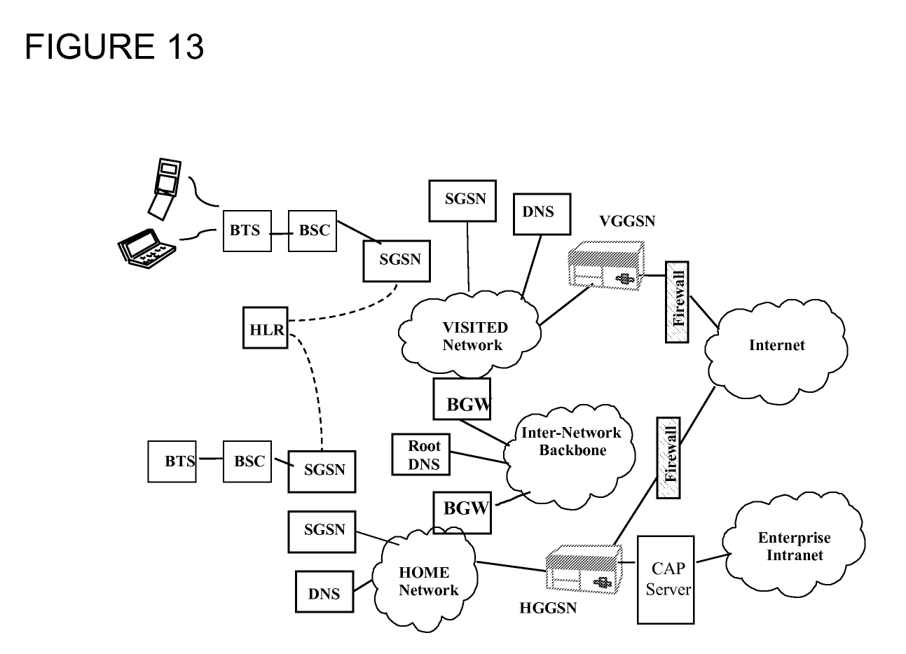

An enterprise customer with a mobile station running a virtual private network client on an end-to-end basis also may create a secure tunnel and likely use a transmission control protocol. As discussed above, this can cause significant degradation in performance. To support cost effective and secure access for corporate users, a server providing a pivot/anchor function is a logical solution. FIG. 13 illustrates an embodiment of general packet radio service network including a corporate application pivot server (generally designated a “CAP server”) that provides a pivot/anchor function. The corporate application pivot server provides a single point of interconnection for a large corporation to reach the mobile users. The corporate application pivot server provides an economical concentration and a remote virtual private network function on behalf of a corporation. To achieve the same level of security, a company would need to have a private facility to every possible network provider or every user would have to reestablish their virtual private network on an end-to-end basis every time they moved from one area to another. While the corporate application pivot server is important for roaming within a single network type, it also offers additional functionality when users roam across different types of networks.

In summary, the need for an enterprise to deploy mobile applications to improve their competitive position has never been greater. Corporate security and a reasonable expectation of success are the overriding factors for deciding what, when, and how these applications will be deployed. While there have been many attempts to create a viable mobile data market, for the first time there are non-proprietary wide area data networks, broadband wireless local area networks, and small high performance wireless devices available to support the whole range of possible applications.

The network architecture described herein deploys point-to-multipoint networks and interfaces the point-to-multipoint networks with greater mobile networks. There have been many attempts to service wireless local area network hotspots. The previous network architectures, however, do not scale beyond single areas or single served market segments. The tiered wireless network architecture achieves scale and scope by deploying a network to meet the needs of multiple market segments all sharing a common architecture. It is easily scalable from a local neighborhood to full nationwide coverage.

Thus, a tiered wireless network architecture has been introduced that concentrates a cluster of wireless router access points to concentrator wireless router access points to achieve much better economies of scale and a better balanced traffic load from the concentrator wireless router access point within the back haul/aggregation network. A wireless mesh technology connects wireless router access points within a cluster to service a local area and offer a number of significant advantages. For instance, mesh networks are unique in their ability to be self-healing. This fail-soft feature allows the network to provide reasonable performance even when a single access point has failed. In addition, a total capacity of the network available to any single user can be greater because the user can be served by more than one wireless router access point or through more than one path.

There are a wide variety of radio protocols at different frequencies that might be used for the mesh network operating in the cluster. If the same frequencies are used in the mesh network as the radio from the wireless router access points (or repeater) to the user, radio interference and traffic congestion may be an issue. Using a higher bandwidth technology for the mesh network than for the point-to-multipoint network provides a better opportunity for better throughput to the users. Capturing the signal at the window or wall of a commercial establishment and repeating the signal at permissible low power levels inside the establishment can also improve providing adequate service to the user. This service extending function can include all of the functionality found in the wireless router access point or a reduced set of functions if appropriate.

Additionally, the tiered wireless network architecture as described herein functions in an independent and autonomous mode when serving either local fixed customers or ad hoc users. Roaming within a cluster is handled in a totally transparent manner, as a part of the point-to-multipoint protocol design, and the network requires little, if any, modification. While there may be many clusters in a neighborhood, the clusters need not be contiguous and users who do not have a dual mode capability (e.g., 802.11 and general packet radio service or other wide area protocol) will reinitiate their session when migrating from one cluster to another.

For the users with dual mode capability, authentication, authorization and accounting functions will be performed within a partner/customer function by a cellular partner in a home network when the multimedia system is serving customers of a participating cellular partner. A throughput of the network described herein is significantly higher than a wide area network and a corporate application pivot server, through a caching function, can increase a performance of the applications and adjust for the difference in bandwidth and persistence.

Additionally, exemplary embodiments of the present invention have been illustrated with reference to specific electronic components. Those skilled in the art are aware, however, that components may be substituted (not necessarily with components of the same type) to create desired conditions or accomplish desired results. For instance, multiple components may be substituted for a single component and vice-versa. The principles of the present invention may be applied to a wide variety of network topologies.

Although the present invention has been described in detail, those skilled in the art should understand that they can make various changes, substitutions and alterations herein without departing from the spirit and scope of the invention in its broadest form.

What is claimed is:

1. A wireless router access point for use with a mesh network employing a mesh protocol and a point-to-multipoint network employing a point-to-multipoint protocol, comprising:
a mesh access point subsystem configured to translate between said point-to-multipoint protocol and said mesh protocol simultaneously to provide seamless connectivity from a user device of said point-to-multipoint network and another wireless router access point of said mesh network without being reconfigured; and
a point-to-multipoint access point subsystem configured to translate between said mesh protocol and said point-to-multipoint protocol simultaneously to provide seamless connectivity from said another wireless router access point of said mesh network and said user device of said point-to-multipoint network without being reconfigured.

2. The wireless router access point as recited in claim 1 wherein said point-to-multipoint network is one of a wideband fidelity network employing a 802.11 protocol and a wideband maximum network employing a 802.16 protocol.

3. The wireless router access point as recited in claim 1 wherein said point-to-multipoint network operates at a different frequency from said mesh network.

4. The wireless router access point as recited in claim 1, further comprising:
a mesh antenna configured to transmit and receive signals to and from said mesh network;
a mesh conditioning input/output filter configured to filter said signals; and
a mesh amplifier configured to amplify said signals for said mesh access point subsystem.

5. The wireless router access point as recited in claim 1, further comprising:
a point-to-multipoint antenna configured to transmit and receive signals to and from said point-to-multipoint network;
a point-to-multipoint conditioning input/output filter configured to filter said signals; and
a point-to-multipoint amplifier configured to amplify said signals for said point-to-multipoint access point subsystem.

6. The wireless router access point as recited in claim 1, further comprising:
a battery back-up configured to provide back-up power for said wireless router access point;
protection subsystems configured to protect said wireless router access point; and
a power conditioning supply configured to condition power to operate said wireless router access point.

7. A method of operating a wireless router access point for use with a mesh network employing a mesh protocol and a point-to-multipoint network employing a point-to-multipoint protocol, comprising:
translating between said point-to-multipoint protocol and said mesh protocol simultaneously to provide seamless connectivity from a user device of said point-to-multipoint network and another wireless router access point of said mesh network without being reconfigured; and
translating between said mesh protocol and said point-to-multipoint protocol simultaneously to provide seamless connectivity from said another wireless router access point of said mesh network and said user device of said point-to-multipoint network without being reconfigured.

8. The method as recited in claim 7 wherein said point-to-multipoint network is one of a wideband fidelity network employing a 802.11 protocol and a wideband maximum network employing a 802.16 protocol.

9. The method as recited in claim 7 wherein said point-to-multipoint network operates at a different frequency from said mesh network.

10. The method as recited in claim 7, further comprising:
transmitting and receiving signals to and from said mesh network;
filtering said signals; and
amplifying said signals associated with said mesh network.

11. The method as recited in claim 7, further comprising:
transmitting and receiving signals to and from said point-to-multipoint network;
filtering said signals; and
amplifying said signals associated with said point-to-multipoint network.

12. The method as recited in claim 7, further comprising:
providing back-up power for said wireless router access point;
protecting said wireless router access point; and
conditioning power to operate said wireless router access point.

13. A multimedia system, comprising:
a wireless router access point configured to translate between a mesh protocol and a point-to-multipoint protocol simultaneously to provide seamless connectivity between another wireless router access point employing said mesh protocol and a user device employing said point-to-multipoint protocol; and
a cluster feeder configured to provide a bridging function between said wireless router access point and said user device.

14. The multimedia system as recited in claim 13 further comprising a concentrator wireless router access point, including:
a wireless router access point subsystem configured to provide a wireless interface and functionality to communicate with said wireless router access point and said another wireless router access point, and
a control/interface subsystem configured to provide control functions to manage said wireless router access point and said another wireless router access point

15. The multimedia system as recited in claim 13 wherein said cluster feeder provides coverage to areas inaccessible by said wireless router access point.

16. The multimedia system as recited in claim 13 wherein said cluster feeder includes:
a plurality of antennas configured to transmit and receive signals employing said point-to-multipoint protocol;
a plurality of amplifiers configured to amplify ones of said signals; and
a signal sense and gain set module configured to reduce a gain of ones of said plurality of amplifiers.

17. The multimedia system as recited in claim 13 wherein said cluster feeder includes:
a plurality of antennas configured to transmit and receive signals employing said point-to-multipoint protocol;
a plurality of point-to-multipoint network transceivers; and
a channel sense and select module configured to select a quality substantially non-interfering channel to be used by one of said plurality of point-to-multipoint network transceivers.

18. The multimedia system as recited in claim 13 wherein said cluster feeder includes:
a first antenna coupled to a mesh network transceiver configured to establish a communication link with said wireless router access point;
a point-to-multipoint network transceiver, coupled to said mesh network transceiver, configured to provide an interface to said user device via a second antenna; and
a channel sense and select module configured to select a quality substantially non-interfering channel to be used by said point-to-multipoint network transceiver.

19. The multimedia system as recited in claim 13 wherein said point-to-multipoint network is one of a wideband fidelity network employing a 802.11 protocol and a wideband maximum network employing a 802.16 protocol.

20. The multimedia system as recited in claim 13 wherein said point-to-multipoint network operates at a different frequency from said mesh network.
